(19) United States
(12) Patent Application Publication
(10) Pub. No.: US 2014/0086293 A1
(43) Pub. Date: Mar. 27, 2014

(54) RECEIVER AND METHOD OF RECEPTION QUALITY MEASUREMENT USED IN WIRELESS NETWORK

(71) Applicants: NTT DOCOMO, INC., Tokyo (JP); FUJITSU LIMITED, Kawasaki-shi (JP)

(72) Inventor: Chimato KOIKE, Fujisawa (JP)

(73) Assignees: NTT DOCOMO, INC., Tokyo (JP); FUJITSU LIMITED, Kawasaki-shi (JP)

(21) Appl. No.: 14/031,744

(22) Filed: Sep. 19, 2013

(30) Foreign Application Priority Data
Sep. 27, 2012 (JP) 2012-215171

(51) Int. Cl. H04B 17/00

(52) U.S. Cl. CPC H04B 17/0045
USPC 375/224

(57) ABSTRACT

A receiver includes: a measurement unit configured to measure received power of a pilot signal symbol included in a received signal and generate a received power measurement value for each of a plurality of measurement periods; and a calculator configured to calculate received power by calculating a weighted average of a plurality of received power measurement values obtained by the measurement unit based on the numbers of the pilot signal symbols that are included in respective measurement periods.

### CROSS-REFERENCE TO RELATED APPLICATION

This application is based upon and claims the benefit of priority of the prior Japanese Patent Application No. 2012-215171, filed on Sep. 27, 2012, the entire contents of which are incorporated herein by reference.

### FIELD

The embodiments discussed herein are related to a receiver and a reception quality measurement method used in a wireless communication network.

### BACKGROUND

Recently, with an increasing amount of data in wireless communications, a mobile communication system has been put into practical use using orthogonal frequency division multiple access (OFDMA) for realizing high frequency utilization. In the third generation partnership project (3GPP), as one of the mobile telephone systems, the standardization of long term evolution (LTE) has been completed, and a standard specification of LTE-advanced, which is a enhanced scheme of LTE, has been studied.

In LTE and LTE-advanced, orthogonal frequency division multiplexing (OFDM) is adopted in the downlink (DL) for transmitting a signal from a base station to a terminal equipment (mobile station etc.), and single carrier frequency division multiple access (SC-FDMA) is adopted in the uplink (UL) for transmitting a signal from a terminal equipment to a base station.

A downlink signal transmitted from the base station includes a pilot signal. The terminal equipment measures the reception quality of the signal transmitted from the base station using the pilot signal. The pilot signal is called a reference signal (RS) in LTE and LTE-Advanced.

When there are a plurality of base stations, the terminal equipment measures the reception quality corresponding to each base station according to the pilot signal received from each base station. The measurement result may be reported to the base station which is connected to the terminal equipment (called “serving cell”). The base station which accommodates the terminal equipment decides based on the measurement result a base station to which the terminal equipment is to be connected. In this case, a handover is performed as necessary.

Proposed as one of the related techniques is a configuration capable of measuring signal to interface ratio (SIR) with high accuracy in the mobile communication system based on code division multiple access (CDMA) even when abrupt interference occurs. Another related technique proposed is a SIR measurement device capable of measuring SIR with high accuracy in a wide range (for example, Japanese Laid-open Patent Publication No. 2004-320254 and Japanese Laid-open Patent Publication No. 2005-12656). In addition, the specifications above are described in, for example, 3GPP TS 36.211 V9.1.0, and 3GPP 36.214 V9.2.0.

A well-known method for suppressing noise in measuring the reception quality is to calculate an average of a plurality of pilot signals obtained in a specified length of measurement period. In this case, when the measuring time is long, the noise is sufficiently suppressed. However, for example, when the terminal equipment is mobile, the terminal equipment may be incapable of correctly measuring the reception quality with long measurement time.

The terminal equipment may measure reception quality in each of a plurality of short periods and calculate a weighted average of the measurement results based on propagation environment. In this method, an error caused by a movement of the terminal equipment may be suppressed. In this case, the terminal equipment estimates as a propagation environment, for example, the number of significant paths, a standard deviation of desired wave power, a standard deviation of a SIR, a Doppler frequency, etc. However, it is difficult to estimate the propagation environment constantly with high accuracy. Therefore, when the estimation accuracy of the propagation environment is low, the reliability of the measurement result of the reception quality is also reduced. Furthermore, since the process of estimating the propagation environment is subject to computational complexity, there is the possibility of large power consumption in the terminal equipment.

### SUMMARY

According to an aspect of the embodiments, a receiver includes: a measurement unit configured to measure received power of a pilot signal symbol included in a received signal and generate a received power measurement value for each of a plurality of measurement periods; and a calculator configured to calculate received power by calculating a weighted average of a plurality of received power measurement values obtained by the measurement unit based on the numbers of the pilot signal symbols that are included in respective measurement periods.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a wireless communication system in which a receiver according to an embodiment of the present invention is used;

FIG. 2 illustrates a structure of a downlink subframe;

FIG. 3 illustrates a configuration of a receiver according to an embodiment of the present invention;

FIG. 4 illustrates an example of measuring RSRP when a terminal equipment remains stationary;

FIG. 5 illustrates an example of measuring RSRP when a terminal equipment is moving;

FIG. 6 illustrates an example of a configuration of an RSRP measurement unit;

FIG. 7 illustrates the allocation of subframes in the downlink in FDD mode;

FIG. 8 illustrates the allocation of subframes in TDD mode;

FIG. 9 illustrates a structure of a special subframe;

FIGS. 10A-10C illustrate examples of the allocation of reference signal symbols;

FIG. 11 illustrates the channel allocation in a subframe;

FIG. 12 illustrates an example of the allocation of broadcast information transmitted from a base station;

FIG. 13 is an explanatory view of calculating RSRP according to the first embodiment;

FIG. 14 is an explanatory view of calculating RSRP according to the second embodiment;

FIG. 15 is an explanatory view of a simulation model for the measurement accuracy of RSRP;

FIGS. 16A-16C illustrate simulation results of RSRP;

FIG. 17 illustrates the probability density function of RSRP calculated without weighting;

FIG. 18 illustrates the probability density function of RSRP calculated in the method according to the first embodiment;

FIG. 19 illustrates the probability density function of RSRP calculated in the method according to the second embodiment; and

FIGS. 20A and 20B illustrate examples of a handover operation based on RSRP.

### DESCRIPTION OF EMBODIMENTS

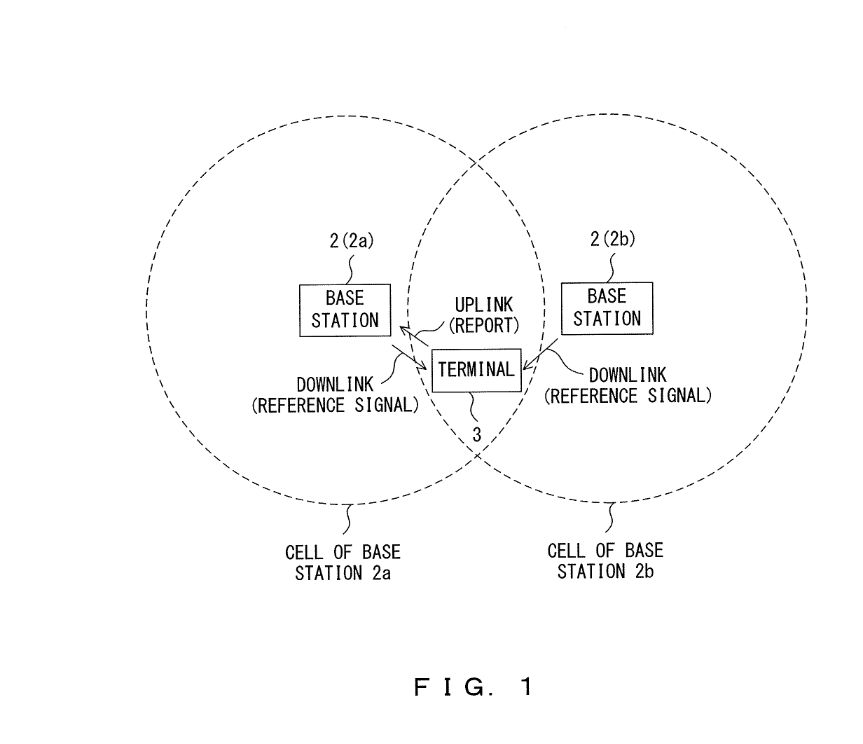

FIG. 1 illustrates an example of a wireless communication system in which a receiver according to an embodiment of the present invention is used. A wireless communication system 1 illustrated in FIG. 1 is not specifically limited, but is supposed to support LTE and LTE-Advanced of the 3GPP.

The wireless communication system 1 includes a plurality of base stations 2 (2a, 2b). Each base station 2 may communicate with a terminal equipment located in a cell. A cell refers to an area in which the base station 2 can communicate.

Terminal equipment 3 is, for example, a mobile station such as a mobile telephone terminal etc. The terminal equipment 3 may communicate with one of the plurality of base stations 2. In FIG. 1, the terminal equipment 3 communicates with the base station 2a.

Each base station 2 transmits a downlink signal to a terminal equipment located in the local cell. In the downlink, OFDMA is used in this example. Therefore, the terminal equipment 3 receives a downlink signal from the base station 2a. Since the terminal equipment 3 is also located in the cell of the base station 2b, the downlink signal transmitted from the base station 2b also arrives at the terminal equipment 3. The downlink signal transmitted from the base station 2 may include a reference signal described later.

The terminal equipment 3 transmits an uplink signal to a serving base station. In the example illustrated in FIG. 1, the base station 2a operates as a serving base station for the terminal equipment 3. In this case, the terminal equipment 3 transmits an uplink signal to the base station 2a. In the uplink, SC-FDMA is used in this example. The terminal equipment 3 reports the measurement result of the reception quality to the serving base station.

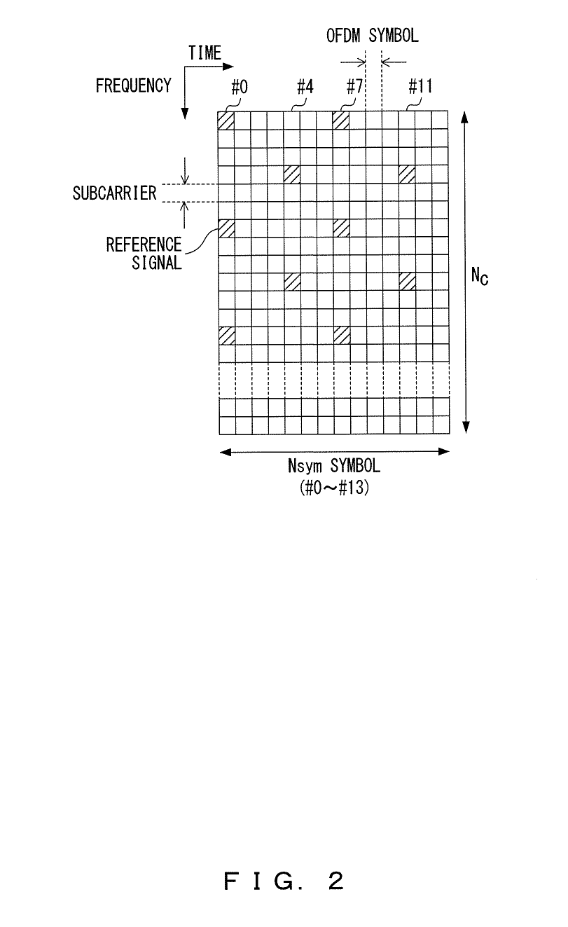

FIG. 2 illustrates a structure of a subframe transmitted through the downlink. In the downlink, data is transmitted using a plurality of subcarriers of different frequencies. In FIG. 2, Nc refers to the number of subcarriers of the downlink. The number of subcarriers may depend on the communication bandwidth of the downlink. Each subcarrier may transmit a modulated signal of QPSK (quadrature phase shift keying), 16QAM (quadrature amplitude modulation), 64QAM d, etc.

One subframe is configured by N_{sym} OFDM symbols. An OFDM symbol includes symbols transmitted through respective subcarriers. That is, the OFDM symbol is configured by Nc symbols. N_{sym} is, for example, 14. However, N_{sym} is not limited to 14. Furthermore, a radio frame is formed by 10 consecutive subframes. The downlink subframes of LTE and LTE-Advanced are described in 3GPP TS36.214 V9.2.0.

In the downlink, the base station 2 transmits a reference signal (RS). The reference signal is an example of a pilot signal. The reference signal is used in measuring the power of a signal received by the terminal equipment 3 from the base station 2 in this specification, but may be applied to other uses.

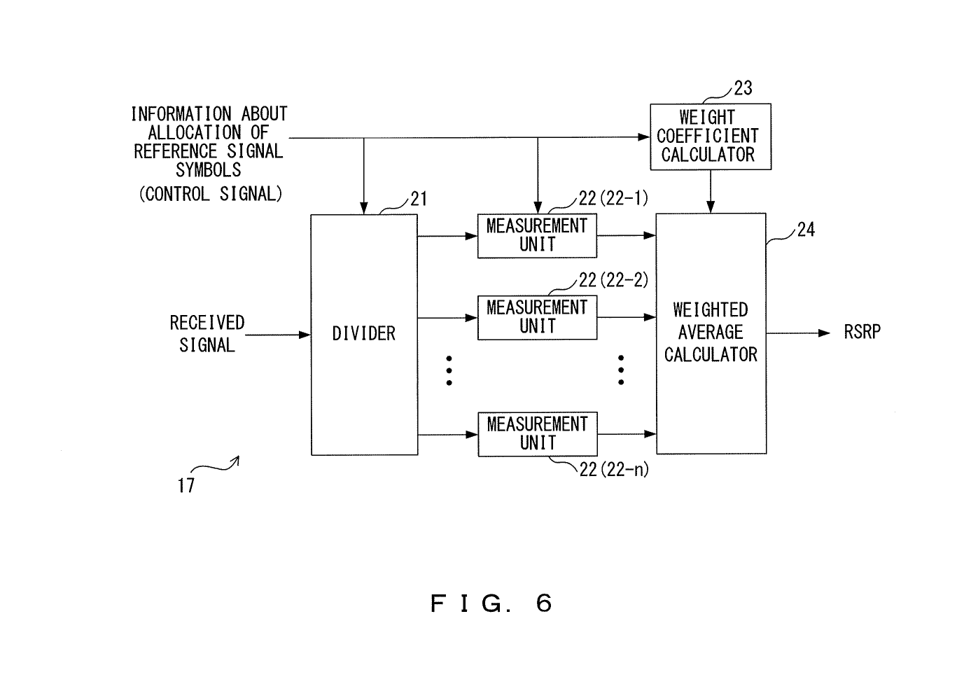

Reference signals are allocated at the intervals of 6 subcarriers in one or more OFDM symbols in a subframe. In the example illustrated in FIG. 6, Nc/6 reference signals are allocated at OFDM symbols #0, #4, #7, and #11.

The reference signal is known to the base station 2 and the terminal equipment 3. Therefore, when the reference signal transmitted from the base station 2 is compared with the reference signal received by the terminal equipment 3, the state of the propagation path between the base station 2 and the terminal equipment 3 may be detected. For example, since the transmitted power of the reference signal from the base station 2 is known, the state of the propagation path is detected by detecting the received power of the reference signal in the terminal equipment 3.

While communicating with the base station 2, the terminal equipment 3 periodically measures the reception quality of each cell. In the example illustrated in FIG. 1, while communicating with the base station 2a, the terminal equipment 3 measures the reception quality of the cell of the base station 2a and the reception quality of the cell of the base station 2b. Then, the terminal equipment 3 reports the measured reception quality to the serving base station (base station 2a in this example). By so doing, the serving base station determines the optimum cell for the terminal equipment 3. If the cell of the base station other than the serving base station is the optimum, the serving base station perform a handover.

The reception quality reported from a terminal equipment to a base station is, for example, a received signal strength indicator (RSSI), reference signal received power (RSRP), reference signal received quality (RSRQ), etc. This report is called “Measurement Report” in LTE and LTE-Advanced.

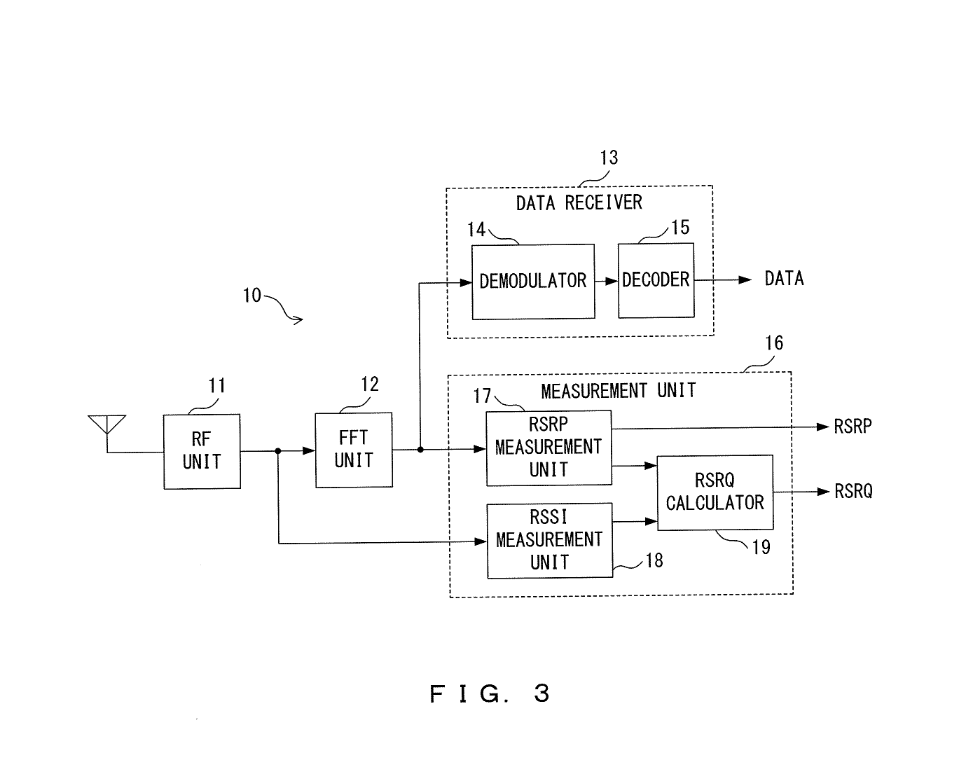

FIG. 3 illustrates a configuration of a receiver according to an embodiment of the present invention. A receiver 10 according to the embodiment includes a radio frequency (RF) unit 11, a fast Fourier transform (FFT) unit 12, a data receiver 13, and a measurement unit 16 as illustrated in FIG. 3. The FFT unit 12, the data receiver 13, and the measurement unit 16 are not specifically limited, but are realized by, for example, a digital signal processor. However, the FFT unit 12, the data receiver 13, and the measurement unit 16 may be realized by a hardware circuit, or a combination of a hardware circuit and a digital signal processor. The receiver 10 is implemented in the terminal equipment 3.

The RF unit 11 converts a received signal input through an antenna into a baseband digital signal. That is, the RF unit 11 converts an OFDM signal transmitted from the base station 2 into a baseband digital signal.

The FFT unit 12 transforms a time domain signal into a frequency domain signal by FFT operation. That is, the FFT unit 12 generates a frequency domain signal from the baseband digital signal output from the RF unit 11. As a result, modulated signals transmitted through respective subcarriers of the OFDM signal are obtained. For example, when a subframe in the format illustrated in FIG. 2 is transmitted from the base station 2, the FFT unit 12 generates Nc modulated signals.

The data receiver 13 recovers transmission data from the frequency domain signal output from the FFT unit 12. The data receiver 13 includes a demodulator 14 and a decoder 15. The demodulator 14 demodulates the frequency domain signal. That is, the demodulator 14 demodulates respective modulated signals transmitted through the subcarriers. In this case, the demodulator 14 may perform the demodulation using a result of the channel estimation. Furthermore, the decoder 15 decodes a received signal demodulated by the demodulator 14 to recover the transmission data.

The measurement unit 16 measures or calculates the reception quality of the downlink signal transmitted from the base station 2. The reception quality measured or calculated by the measurement unit 16 is RSRP, RSSI, and RSRQ. Therefore, the measurement unit 16 includes an RSRP measurement unit 17, an RSSI measurement unit 18, and an RSRQ calculator 19.

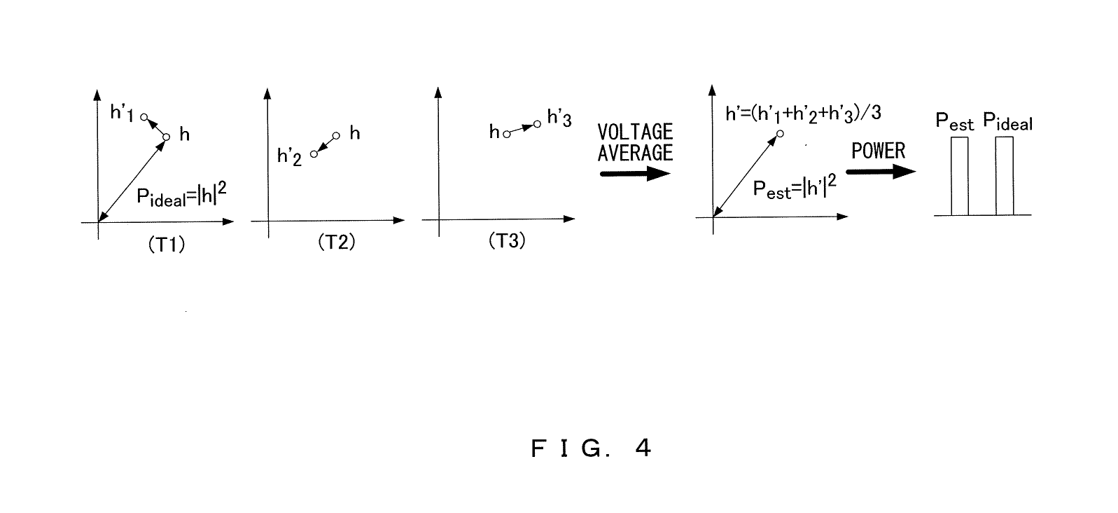

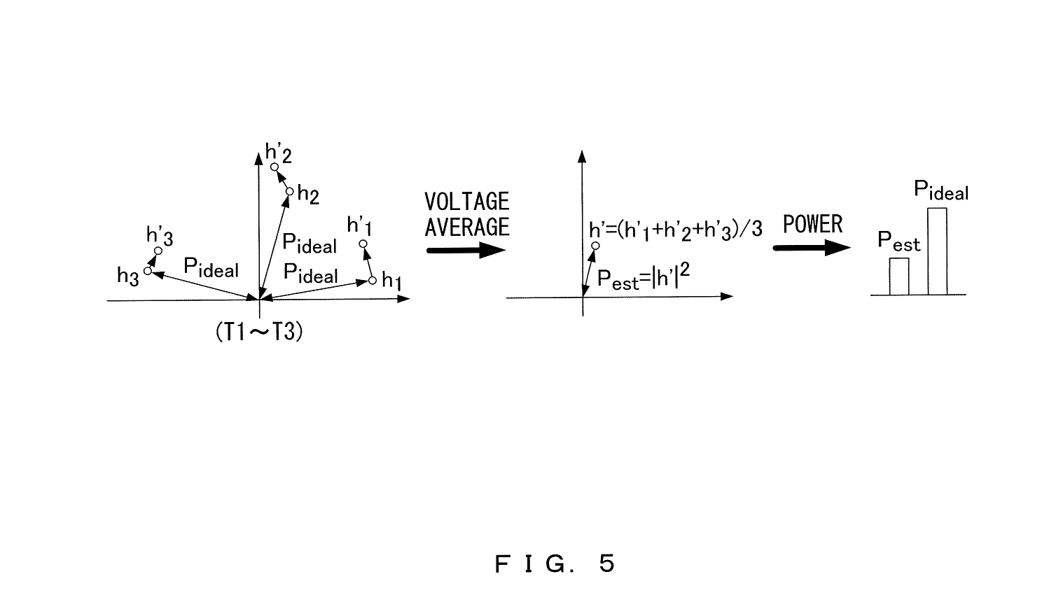

The RSRP measurement unit 17 measures RSRP using the frequency domain signal (that is, Nc modulated signals) output from the FFT unit 12. In this case, the RSRP measurement unit 17 measures the received power of the reference signal symbol allocated in the subframe illustrated in FIG. 2. The method for measuring RSRP is described below with reference to FIGS. 4 and 5.

FIG. 4 illustrates an example of measuring RSRP when the terminal equipment 3 remains stationary. The terminal equipment 3 estimates the channel state between the base station 2 and the terminal equipment 3. The channel state is expressed by a complex number. The complex number is obtained by detecting the I and Q components of the received reference signal.

The terminal equipment 3 estimates the channel state at time T1, T2, and T3. In the embodiment, the terminal equipment 3 remains stationary. Therefore, if it is assumed that there is no noise, the channel state h remains unchanged during T1-T3 as illustrated in FIG. 4.

However, noise exists in the actual wireless communication system. Therefore, the channel state estimated from the received reference signal in the terminal equipment 3 is affected by the noise. In the example in FIG. 4, the channel states h′₁, h′₂, and h′₃ are respectively detected at time T1, T2, and T3.

The RSRP measurement unit 17 suppresses the noise power by averaging the received signals including the noise. The RSRP measurement unit 17 then measures the received power according to the noise suppressed signal. For example, when the channel states h′₁, through h′₃ are obtained at time T1 through T3, respectively, the RSRP measurement unit 17 first obtains the average channel state h′ by the following formula. The averaging operation is a complex average (voltage average).

h′=(h′₁+h′₂+h′₃)/3

Then the RSRP measurement unit 17 calculates the received power Pₑₛₜ from the average channel state h′ by the following formula.

Pₑₛₜ=|h′|²

Since the noise power is suppressed by the averaging operation, the average channel state h′ is approximate to the ideal channel state h. Therefore, the received power Pₑₛₜ calculated from the average channel state h′ is approximate to the ideal value P_{ideal} of the received power. The received power Pₑₛₜ is output as RSRP indicating the received power of the reference signal.

Note that the noise suppression effect becomes higher if the averaging operation is performed by acquiring more reference signal symbols in the time domain. That is, if the averaging time is longer, the noise suppression effect becomes higher.

FIG. 5 illustrates an example of measuring RSRP while the terminal equipment 3 is moving. When the terminal equipment 3 is moving, the channel state changes with respect to time. That is, with the lapse of time, the amplitude and/or phase of the received reference signal at the terminal equipment 3 changes. Especially, while the terminal equipment 3 is moving at a higher speed, the channel state changes larger with respect to time. In the example illustrated in FIG. 5, the channel states h₁, h₂, and h₃ are obtained respectively at time T1, T2, and T3. Furthermore, since there is noise, the channel states estimated at time T1, T2, and T3 are respectively h′₁, h′₂, and h′₃.

In this case, when the above-mentioned averaging operation is performed on the channel states h′₁, h′₂, and h′₃, the coordinates indicating the average channel state h′ appears at the position closer to the origin in the constellation than the actual channel state as illustrated in FIG. 5. Therefore, the received power Pₑₛₜ calculated from the average channel state h′ is lower than the ideal value P_{ideal} of the received power.

Thus, when the terminal equipment 3 is moving at a high speed, the error of RSRP indicating the received power of the reference signal becomes large. The longer the averaging time is, the larger the error becomes. Therefore, it is preferable that the averaging time for measuring RSRP is appropriately determined considering both the noise suppression and the error caused by the movement of the terminal equipment 3.

Back in FIG. 3, the RSSI measurement unit 18 measures RSSI indicating the strength of the received signal using the baseband digital signal output from the RF unit 11. The RSRQ calculator 19 calculates RSRQ indicating the quality of the reference signal from RSRP obtained by the RSRP measurement unit 17 and RSSI obtained by the RSSI measurement unit 18. The details of the RSSI measurement and the RSRQ measurement are omitted.

The measurement unit 16 reports RSRP and RSRQ obtained as described above to the serving base station. By so doing, according to the report, the serving base station determines the optimum cell of the terminal equipment 3, and performs a handover as necessary.

FIG. 6 illustrates an example of a configuration of the RSRP measurement unit 17. As illustrated in FIG. 6, the

RSRP measurement unit 17 includes a divider 21, a plurality of measurement units 22 (22-1 through 22-n), a weight coefficient calculator 23, and a weighted average calculator 24. A received signal is fed to the RSRP measurement unit 17. The received signal is a frequency domain signal output from the FFT unit 12 (that is, Nc modulated signals). Furthermore, the RSRP measurement unit 17 receives a control signal. The control signal includes the information about the allocation of reference signal symbols as described later in detail.

In the RSRP measurement unit 17, as illustrated in FIG. 6, the divider 21, the plurality of measurement units 22, and the weight coefficient calculator 23 operate according to the control signal. Therefore, the control signal is first described below.

In LTE and LTE-Advanced, frequency division duplex (FDD) and time division duplex (TDD) are supported as the methods of multiplexing an uplink and a downlink. In FDD, the uplink communication and the downlink communication are multiplexed by assigning different frequencies to the uplink and the downlink. On the other hand, in TDD, the same frequency is assigned to the uplink and the downlink, and the uplink communication and the downlink communication are multiplexed in time domain.

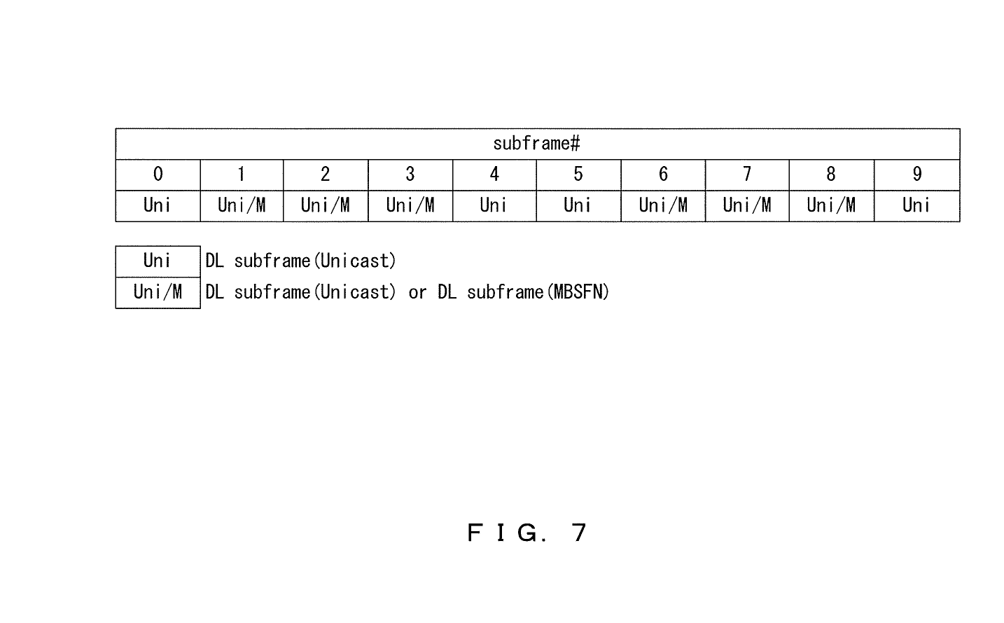

FIG. 7 illustrates the allocation of subframes in the downlink of in FDD mode. In FIG. 7, the subframes are allocated in one radio frame. In the following explanation, the downlink subframe may be expressed as a “DL subframe”.

In the downlink of FDD mode, DL subframe (unicast) or DL subframe (MBSFN) is transmitted from a base station. DL subframe (unicast) is used to transmit data to a target terminal equipment. DL subframe (MBSFN) is used for multimedia broadcast and a broadcast service (multimedia broadcast and multicast service (MBMS)). MBSFN refers to a MBMS single frequency network. In the following explanation, DL subframe (unicast) may be called “unicast subframe”, and DL subframe (MBSFN) may be called “MBSFN subframe”.

In the downlink in FDD mode, unicast subframe is allocated in subframes #0, #4, #5, and #9 in a radio frame. Furthermore, unicast subframe or MBSFN subframe is allocated in subframes #1 #2, #3, #6, #7, and #8 in the radio frame. For example, a base station determines whether unicast subframe or MBSFN subframe is allocated in each of subframes #1 #2, #3, #6, #7, and #8.

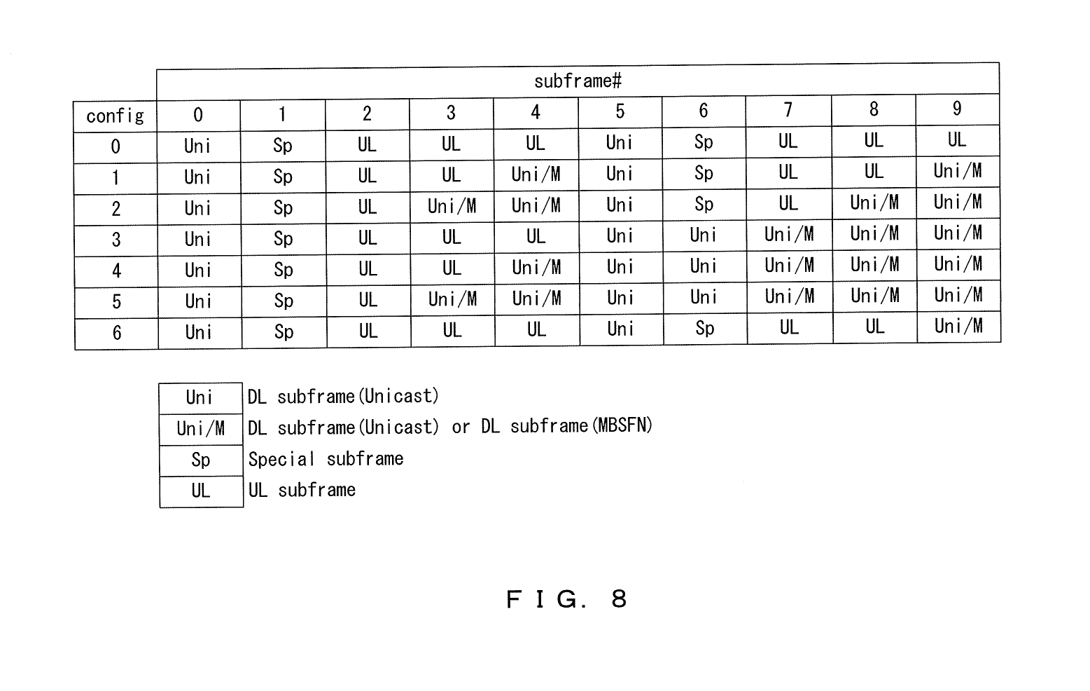

FIG. 8 illustrates the allocation of subframes in TDD mode. In TDD mode, downlink subframe (unicast subframe, MBSFN subframe), special subframe, and uplink subframe may be accommodated in a radio frame. Furthermore, LTE and LTE-Advanced provide seven uplink/downlink configurations illustrated in FIG. 8 as the allocation pattern of unicast subframe, MBSFN subframe, special subframe and uplink subframe.

For example, in the uplink/downlink configuration 0, unicast subframe is allocated in subframes #0 and #5, special subframe is allocated in subframes #1 and #6, and uplink subframe is allocated in subframes #2 through #4 and #7 through #9. In the uplink/downlink configuration 1, unicast subframe is allocated in subframes #0 and #5, special subframe is allocated in subframes #1 and #6, uplink subframe is allocated in subframes #2, #3, #7, and #8, and unicast subframe or MBSFN subframe is allocated in subframes #4 and #9. For example, a base station determines which uplink/downlink configuration is to be used. Also, in TDD mode, for example, a base station determines which is to be allocated, unicast subframe or MBSFN subframe, in a subframe in which unicast subframe or MBSFN subframe may be selected,

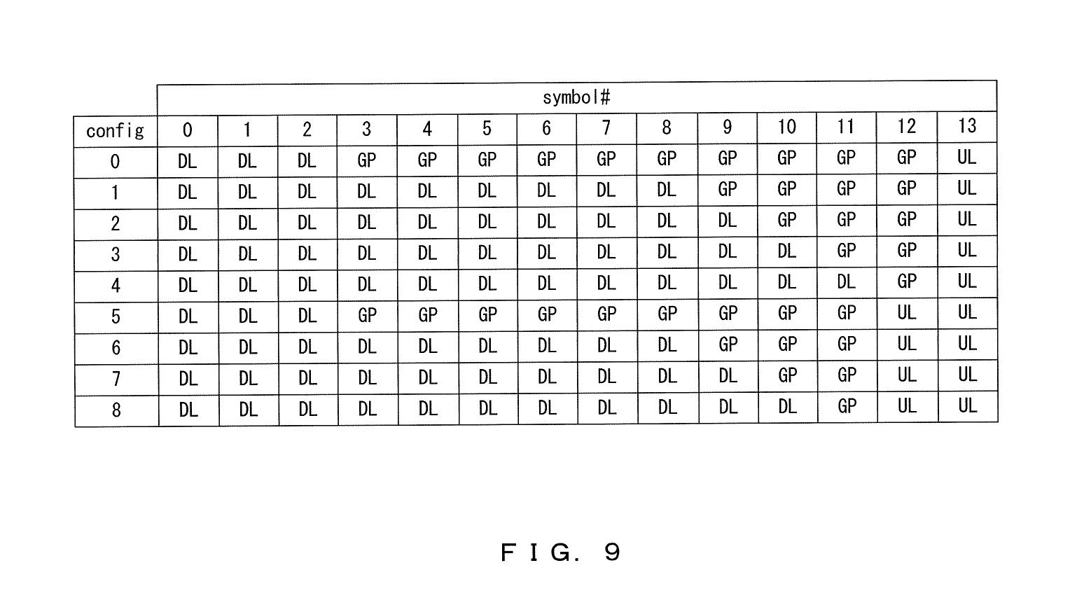

FIG. 9 illustrates a structure of a special subframe. It is assumed that a subframe includes 14 OFDM symbols (N_{sym}=14). In FIG. 9, DL indicates a downlink, UL indicates an uplink, and GP indicates a guard period.

Special subframe includes a downlink symbol, a guard period, and an uplink symbol. The guard period is provided to switch from a downlink reception mode to an uplink transmission mode in the terminal equipment 3. In LTE and LTE-Advanced, nine special subframe configurations illustrated in FIG. 9 are provided as the allocation patterns of a downlink symbol, a guard period, and an uplink symbol in a special subframe.

For example, in the special subframe configuration 0, a downlink symbol is allocated in symbol #0 through #2, a guard period is allocated in symbol #3 through #12, and an uplink symbol is allocated in symbol #13. For example, a base station determines which special subframe configuration is to be used.

Thus, in FDD mode, each radio frame may include unicast subframe and MBSFN subframe as illustrated in FIG. 7. Furthermore, in TDD mode, each radio frame may include unicast subframe, MBSFN subframe, special subframe, and uplink subframe as illustrated in FIG. 8.

However, the number of reference signal symbols allocated in a subframe depends on the type of subframe. In addition, the number of reference signal symbols allocated in the special subframe depends on the special subframe configuration.

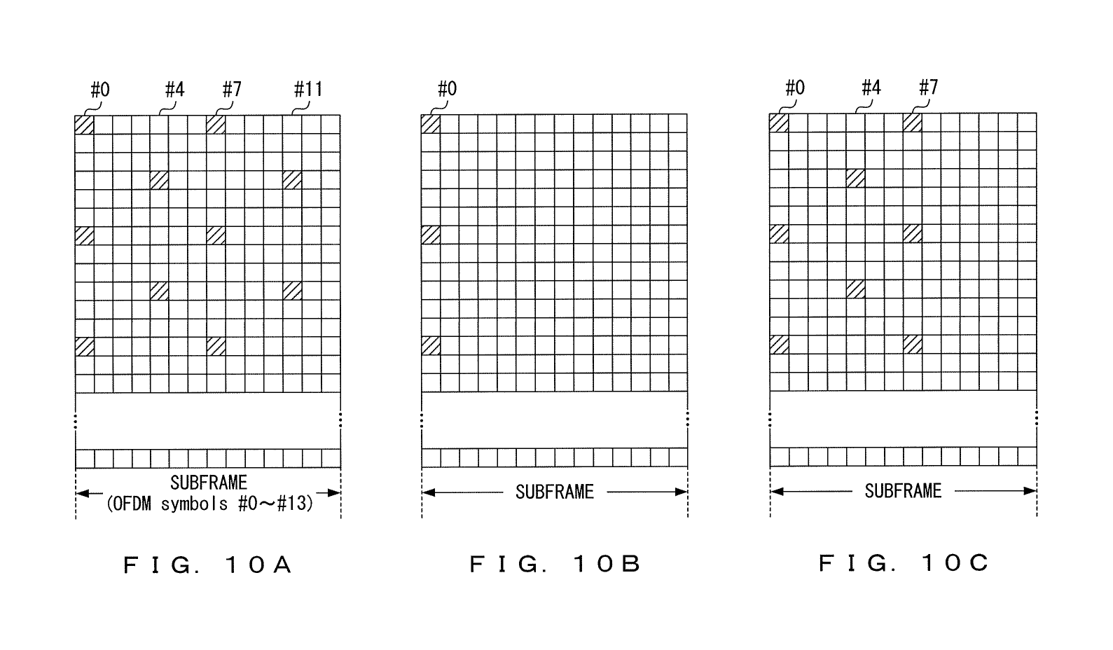

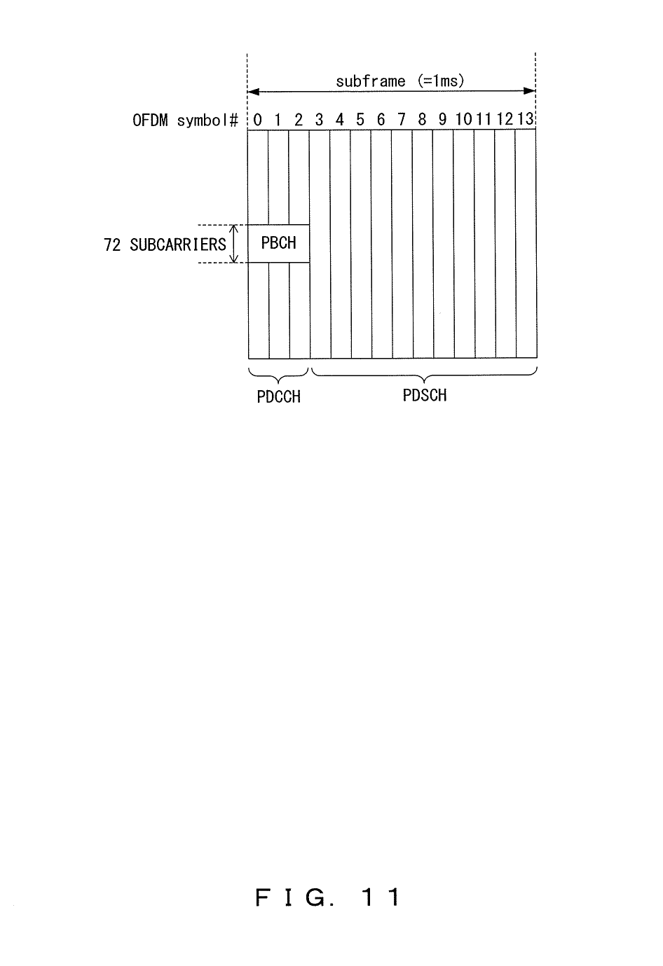

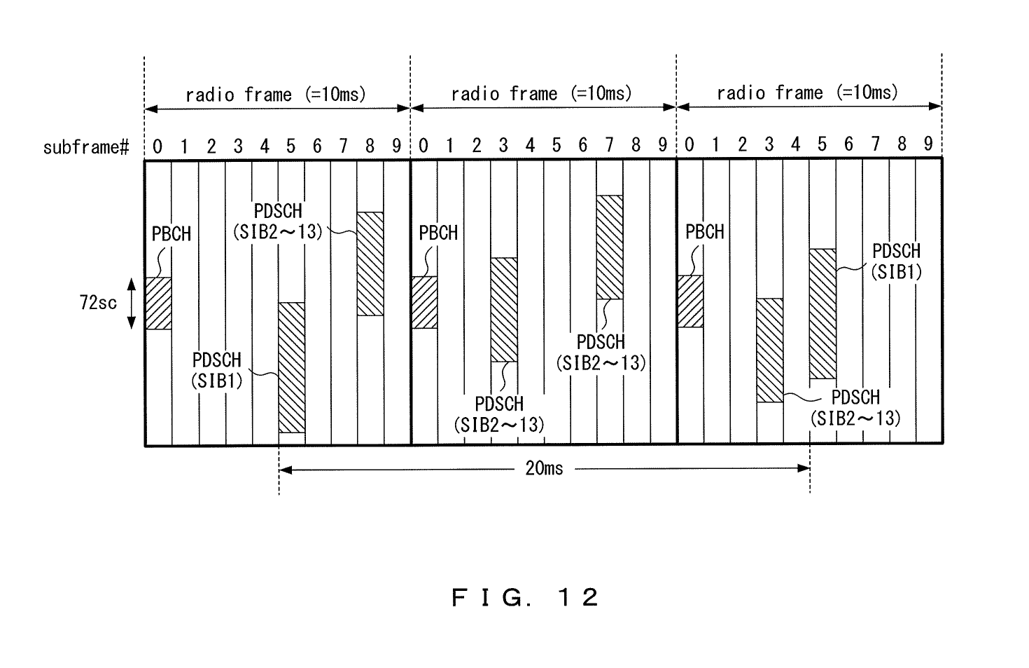

In the unicast subframe, as illustrated in FIG. 10A, a reference signal is allocated in OFDM symbols #0, #4, #7, and #11. In FIGS. 10A-10C, the shaded area indicates a reference signal symbol allocated in the subframe. When a reference signal is allocated in the OFDM symbol, the reference signal symbols are allocated at the intervals of 6 subcarriers. Therefore, when OFDM signal of Nc subcarriers carries data, 4×(Nc/6) reference signal symbols are allocated in the unicast subframe.

In the MBSFN subframe, as illustrated in FIG. 10B, a reference signal is allocated only in OFDM symbol #0. Therefore, when OFDM signal of Nc subcarriers carries data, 1×(Nc/6) reference signal symbols are allocated in the MBSFN subframe.

In the special subframe, a reference signal is allocated in the symbol to which a downlink is assigned in OFDM symbols #0, #4, #7, and #11. Therefore, in the special subframe of the configurations 0 and 5, a reference signal is allocated only in OFDM symbol #0 as illustrated in FIG. 10B. In the special subframe of the configurations 1 through 3, and 6 through 8, a reference signal is allocated in OFDM symbols #0, #4, and #7 as illustrated in FIG. 10C. In the special subframe of the configuration 4, a reference signal is allocated in OFDM symbols #0, #4, #7, and #11 as illustrated in FIG. 10A. Note that no reference signal symbol is allocated in the uplink subframe.

In summary, the numbers of reference signal symbols allocated in respective subframes are listed below. However, the number of reference signals allocated in one OFDM symbol is Nc/6 regardless of the type of subframe as described above with reference to FIGS. 10A-10C. Therefore, the number of reference signal symbols allocated in a subframe is proportional to the number of OFDM symbols in which the reference signal symbols are allocated in the subframe. That is, the number of reference signal symbols allocated in a subframe uniquely corresponds to the number of OFDM symbols in which the reference signal symbols are allocated in the subframe. Therefore, in this example, the number of reference signal symbols allocated in a subframe refers to the number of OFDM symbols in which a reference signal symbol is allocated in the subframe.
unicast subframe: 4
MBSFN subframe: 1
special subframe (configurations 0, 5): 1
special subframe (configuration 1, 2, 3, 6, 7, 8): 3
special subframe (configuration 4): 4
uplink subframe: 0

The RSRP measurement unit 17 of the terminal equipment 3 measures RSRP considering the number of reference signal symbols allocated in each subframe as described later in detail. Therefore, the RSRP measurement unit 17 is provided with the information for specifying the allocation of the reference signal symbol.

The base station 2 transmits a control signal including the information for specifying the allocation of the reference signal symbol to the terminal equipment 3 located in the cell. The control signal includes, for example, the following information.
(1) uplink/downlink configuration
(2) MBSFN subframe configuration
(3) special subframe configuration

The uplink/downlink configuration specifies the allocation pattern of the unicast subframe, the MBSFN subframe, the special subframe, and the uplink subframe as described above with reference to FIG. 8. The MBSFN subframe configuration specifies the position in which the MBSFN subframe is allocated as described above with reference to FIGS. 7 and 8. The special subframe configuration specifies the allocation pattern of the downlink symbol, the guard period, and the uplink symbol as described above with reference to FIG. 9. Note that the base station 2 may notify the terminal equipment 3 of the information for specification of FDD mode or TDD mode.

Described next is the method of notifying the terminal equipment 3 of the configuration information from the base station 2. In this method, it is assumed that a communication is performed in LTE or LTE-Advanced.

FIG. 11 illustrates the channel allocation in a subframe. Physical broadcast channel (PBCH) and physical downlink shared channel (PDSCH) transmit broadcast information from a base station to a terminal equipment. Physical downlink control channel (PDCCH) transmits information relating to a user allocation of PDSCH, the modulation scheme, etc.

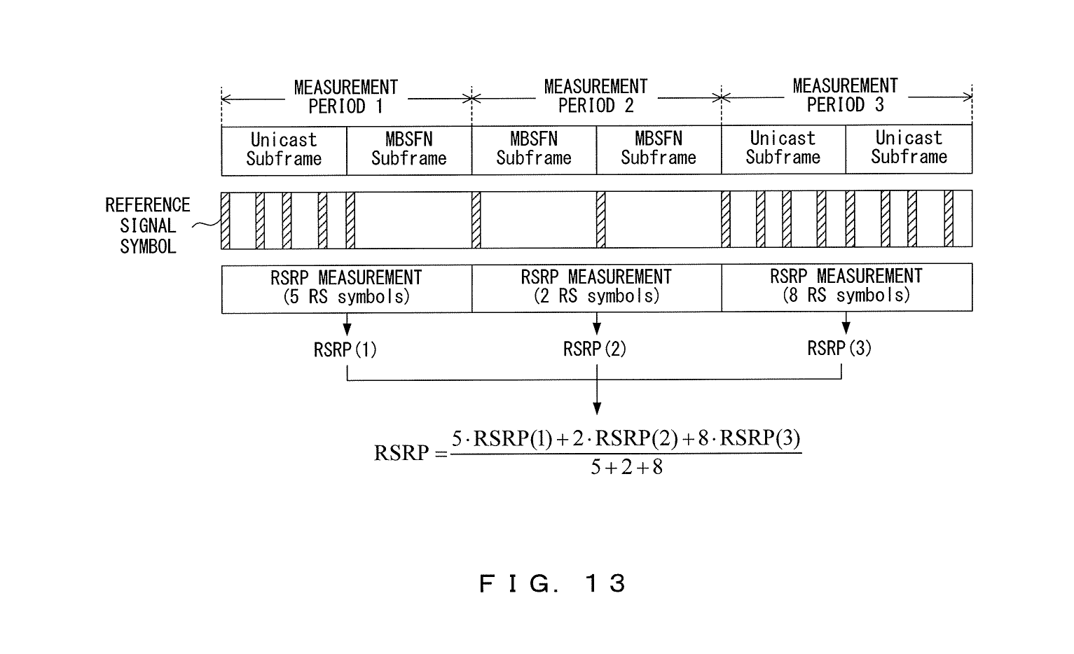

PBCH is allocated in subframe #0 in each radio frame. Specifically, PBCH is fixedly allocated in the central 72 subcarriers in the symbols in which PDCCH is allocated. Therefore, PBCH is allocated fixedly every 10 ms as illustrated in FIG. 12. When starting the communication with the base station, the terminal equipment first receives PBCH to acquire master information block (MIB). By so doing, the terminal equipment can receive PDSCH by acquiring the information included in NIB.

The terminal equipment receives PDSCH allocated in subframe #5 at the 20 ms interval. In this area, system information block type 1 (SIB1) message is allocated. After acquiring SIB1 message, the terminal equipment acquires SIB2 through SIB13 messages. The positions where SIB2 through SIB3 messages are allocated are described in SIB1 message. SIB is described in, for example, 3GPP TS36.331 V10.5.0.

In TDD mode, information element TDD-Config is described in SIB1 message. TDD-Config includes subframeAssignment field indicating uplink/downlink configuration and specialSubframePatterns field indicating special subframe configuration. subframeAssignment specifies any value of 0 through 6. specialSubframePatterns specifies any value of 0 through 8.

SIB2 message describes information element MBSFN-SubframeConfig. MBSFN-SubframeConfig includes a field describing the information about the allocation of MBSFN subframe. That is, MBSFN-SubframeConfig includes a field describing the interval at which a radio frame including MBSFN subframe appears, and the allocation of MBSFN subframe in the radio frame. The allocation of MBSFN subframe in the radio frame is expressed by 6 bits. In the field of the 6 bits, the subframe corresponding to the bit where “1” is set is used as MBSFN subframe. In FDD mode, each bit indicates the state of subframes #1, #2, #3, #6, #7, and #8 in order from the most significant bit. In TDD mode, each bit indicates the state of subframes #3, #4, #7, #8, and #9 in order from the most significant bit. Note that in TDD mode, the least significant bit is not used.

As described above, the base station 2 transmits the control signal including the above-mentioned three pieces of configuration information. Then, the terminal equipment 3 located in the cell of the base station 2 periodically receives the control signal.

The terminal equipment 3 demodulates and decodes the control signal received from the base station 2, and acquires the above-mentioned three pieces of configuration information. The demodulation and decoding of the control signal are performed by, for example, the data receiver 13 illustrated in FIG. 3. In this case, the acquired configuration information is supplied from the data receiver 13 to the RSRP measurement unit 17. The configuration information may be regenerated in the measurement unit 16 from the control signal.

The received signal is fed to the RSRP measurement unit 17 as illustrated in FIG. 6. The received signal is a frequency domain signal output from the FFT unit 12 (that is, Nc modulated signals). Then, the RSRP measurement unit 17 measures the power of the reference signal symbol included in the received signal according to the configuration information received from the base station 2.

The configuration information includes the information which specifies the following (1) through (3).
(1) Allocation pattern of unicast subframe, MBSFN subframe, special subframe, and uplink subframe in a radio frame (refer to FIG. 8)
(2) Position where MBSFN subframe is allocated in the radio frame (refer to FIGS. 7 and 8)
(3) Allocation pattern of downlink symbol, guard period, and uplink symbol in the special subframe (refer to FIG. 9)

Furthermore, it is assumed that the RSRP measurement unit 17 recognizes a multiplexing mode (TDD or FDD) of multiplexing the uplink and the downlink by the notification from the base station 2.

Accordingly, the RSRP measurement unit 17 can detect the allocation of the reference signal symbol in each received subframe. Furthermore, the RSRP measurement unit 17 can detect the number of reference signal symbols in each received subframe (or the number of OFDM symbols in which the reference signal symbol is allocated in each received subframe).

Described next is the operation of the RSRP measurement unit 17. The divider 21 divides a received signal into small sections and sequentially distributes them to the plurality of measurement units 22 (22-1 through 22-n). The length of each small section is determined so that, for example, a noise suppression effect described above with reference to FIG. 4 is obtained. However, if the length of the small section is too long, the measurement error becomes large when the terminal equipment 3 moves at a high speed as described above with reference to FIG. 5. Therefore, it is preferable that the length of the small section is appropriately determined with these factors taken into account. As an example, the length of the small section corresponds to the period of 0.5 through several subframes.

Each measurement unit 22 measures the power of the reference signal symbol included in the received signal distributed from the divider 21. That is, the measurement unit 22 measures RSRP based on the reference signal symbol included in the received signal in the small section. The received signal in one small section includes a plurality of reference signal symbols. Thus, RSRP calculated by the measurement unit 22 is expressed by the following formula. (The following equation is an example of a method for calculating RSRP, and is not limited to the method.)

RSRP=|h′|²

h′=Σ(Aᵢ+jBᵢ)/k

Aᵢ+jBᵢ indicates the channel state (or the reception state of the i-th reference signal symbol) obtained by the i-th reference signal symbol, k indicates the number of reference signal symbols, and h′ indicates an average channel state.

Therefore, the measurement units 22-1 through 22-n measure RSRP1 through RSRPn, respectively. The measurement units 22-1 through 22-n measure corresponding RSRP in different small sections. That is, the measurement units 22-1 through 22-n measure RSRP1 through RSRPn corresponding to different small sections.

Thus, each measurement unit 22 measures RSRP based on the reference signal symbols in the small section. Therefore, the “small section” corresponds to “measurement period” for measurement of RSRP.

The weight coefficient calculator 23 calculates weight coefficients W1 through Wn corresponding to RSRP1 through RSRPn measured by the measurement units 22-1 through 22-n. The weight coefficients W1 through Wn are determined based on the number of reference signal symbols in the measurement periods of the measurement units 22-1 through 22-n. In this case, the weight coefficient calculator 23 determines the weight coefficients W1 through Wn so that, for example, the weight of the measurement value obtained in the measurement period in which there is a small number of reference signal symbols may be small, and the weight of the measurement value obtained in the measurement period in which there is a large number of reference signal symbols maybe large. An embodiment of the method for determining the weight coefficients W1 through Wn is described later.

The weighted average calculator 24 calculates a weighted average using the weight coefficients W1 through Wn calculated by the weight coefficient calculator 23 with respect to RSRP1 through RSRPn measured by the measurement units 22-1 through 22-n. Then, the RSRP measurement unit 17 outputs the calculation result of the weighted average calculator 24 as RSRP to be reported to the base station 2.

Thus, the RSRP measurement unit 17 measures RSRP in a plurality of measurement periods. Then, the RSRP measurement unit 17 calculates the weighted average of the plurality of RSRP measurement values (that is, RSRP1 through RSRPn) using the weight coefficients W1 through Wn.

The RSRP measurement value obtained in each measurement period is calculated based on a plurality of reference signal symbols in the measurement period. For example, assume that the received signal of the measurement period 1 is the subframe illustrated in FIG. 10A, and the received signal of the measurement period 2 is the subframe illustrated in FIG. 10B. In this case, in the measurement period 1, RSRP1 is calculated from the reference signal symbols allocated in OFDM symbol #0, #4, #7, and #11. That is, RSRP1 is calculated from the reference signal symbols allocated at four different time points. On the other hand, in the measurement period 2, RSRP2 is calculated from the reference signal symbols allocated in OFDM symbol #0. That is, RSRP2 is calculated from the reference signal symbols allocated at one time point. Here, the measurement accuracy or reliability in the measurement period where there are a large number of reference signal symbols is high, and the measurement accuracy or reliability in the measurement period where there are a small number of reference signal symbols is low. Thus, in this example, the measurement accuracy or reliability of RSRP1 is higher compared with that of RSRP2.

For the reasons above, the weight coefficients W1 through Wn may be determined so that the weight of the measurement value obtained in the measurement period in which there is a small number of reference signal symbols is small, and the weight of the measurement value obtained in the measurement period in which there is a large number of reference signal symbols is large. Therefore, if the weighted average of RSRP1 through RSRPn is calculated using the weight coefficients W1 through Wn, the contribution of a highly reliable RSRP measurement value becomes high, and the contribution of a less reliable RSRP measurement value becomes low. As a result, the reliability of RSRP obtained by the weighted average is high.

If a propagation environment between the base station and the terminal equipment is estimated in each measurement period, and a weighted average is obtained so that the contribution of the RSRP measurement value in the measurement period in which a propagation environment is inferior may be smaller, then RSRP of high reliability may be obtained. In this case, for example, the number of significant paths, the standard deviation of desired wave power, the standard deviation of SIR, a Doppler frequency, etc. are estimated as the propagation environment. However, it is difficult to estimate the propagation environment constantly with high accuracy. Therefore, when the estimation accuracy of the propagation environment is low, the reliability of the finally obtained RSRP is also low. Furthermore, since the process of estimating the propagation environment is subject to computational complexity, there is the possibility of large power consumption of the terminal equipment.

On the other hand, in the method of the embodiments of the present invention, the weight coefficients W1 through Wn are determined based on the number of reference signal symbols in each measurement period. Therefore, the computational complexity of the process of determining the weight coefficients W1 through Wn is low, thereby requiring smaller power consumption.

### First Embodiment

In the first embodiment, the uplink and the downlink are multiplexed in FDD mode. The RSRP measurement unit 17 measures RSRP from six consecutive subframes. The length of each measurement period is “2 subframes”. Therefore, in the RSRP measurement unit 17, three measurement values (RSRP(1) through RSRP(3)) are obtained using three measurement units 22 (that is, the measurement units 22-1 through 22-3 (n=3)).

The six subframes input to the RSRP measurement unit 17 are “unicast”, “MBSFN”, “MBSFN”, “MBSFN”, “unicast”, and “unicast”. The “unicast” indicates a unicast subframe, and the “MBSFN” indicates a MBSFN subframe.

In this case, the “unicast” and “MBSFN” of the measurement period 1 are input to the measurement units 22-1. The “MBSFN” and “MBSFN” of the measurement period 2 are input to the measurement units 22-2. The “unicast” and “unicast” of the measurement period 3 are input to the measurement units 22-3.

In the unicast subframe, as illustrated in FIG. 10A, a reference signal is allocated in OFDM symbols #0, #4, #7, and #11. That is, in one unicast subframe, 4×(Nc/6) reference signal symbols are allocated. On the other hand, in the MBSFN subframe, as illustrated in FIG. 10B, a reference signal is allocated only in OFDM symbol #0. That is, in one MBSFN subframe, 1×(Nc/6) reference signal symbols are allocated.

Therefore, in the measurement period 1, there are 5×(Nc/6) reference signal symbols. In addition, in the measurement period 2, there are 2×(Nc/6) reference signal symbols. Furthermore, in the measurement period 3, there are 8×(Nc/6) reference signal symbols.

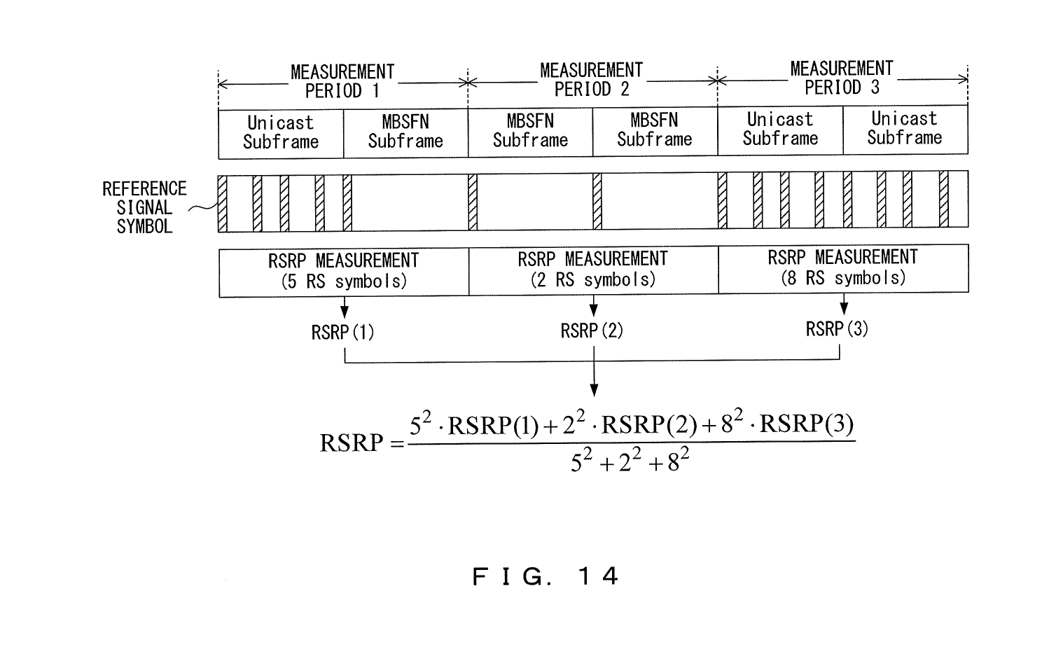

In the first embodiment, the weight coefficient calculator 23 uses the number of reference signal symbols in each measurement period as a weight coefficient. However, Nc/6 is a constant, and common in the measurement periods 1 through 3. Therefore, in the explanation below, “Nc/6” is omitted. That is, the numbers of the reference signal symbols in the measurement periods 1, 2, and 3 are represented by 5, 2, and 8, respectively. Then, when the six subframes illustrated in FIG. 13 are input to the RSRP measurement unit 17, the weight coefficient calculator 23 outputs W1=5, W2=2, and W3=8 respectively as the weight coefficients corresponding to the measurement periods 1, 2, and 3.

The measurement unit 22-1 obtains the received power measurement value RSRP(1) based on a plurality of reference signal symbols included in the received signal of the measurement period 1. Similarly, the measurement units 22-2 and 22-3 obtain the received power measurement value RSRP(2) and RSRP(3), respectively.

The weighted average calculator 24 calculates RSRP of the received signal by calculating a weighted average using the W1 through W3 for RSRP(1) through RSRP(3). The weighted average in the first embodiment is illustrated in FIG. 13.

Thus, in the first embodiment, the number of reference signal symbols in a measurement period is used as a weight coefficient for the measurement period. In this process, the measurement accuracy of RSRP in each measurement period depends on the number of reference signal symbols used in measurement. That is, the measurement accuracy in the measurement period having a large number of reference signal symbols is high, and the measurement accuracy in the measurement period having a small number of reference signal symbols is low. Therefore, in calculating RSRP using the weighted average according to the first embodiment, the influence of the measurement value obtained in a measurement period having a small number of reference signal symbols (the measurement period 2 in FIG. 13) is small, and the influence of the measurement value obtained in a measurement period having a large number of reference signal symbols (the measurement period 3 in FIG. 13) is large. As a result, as compared with the method in which no weighted average is used, the measurement accuracy of RSRP is enhanced.

The number of reference signal symbols in a measurement period is proportional to the number of OFDM symbols in which the reference signal symbols are allocated in the measurement period. Therefore, substantially the same calculation result of a weighted average is obtained when the weight coefficients W1 through Wn are determined based on the “number of the OFDM symbols in which the reference signal symbols are allocated in the measurement period” instead of the “number of the reference signal symbols in the measurement period”. Therefore, in determining the weight coefficients W1 through Wn, the “number of the reference signal symbols in the measurement period” is equivalent to the “number of the OFDM symbols in which the reference signal symbols are allocated in the measurement period”. In addition, in determining the weight coefficients W1 through Wn, the “number of the OFDM symbols in which the reference signal symbols are allocated in the measurement period” is one example of the “number of the reference signal symbols in the measurement period”.

### Second Embodiment

In the first embodiment, the number of reference signal symbols in each measurement period is used as a weight coefficient. On the other hand, in the second embodiment, the square of the number of reference signal symbols in each measurement period is used as a weight coefficient.

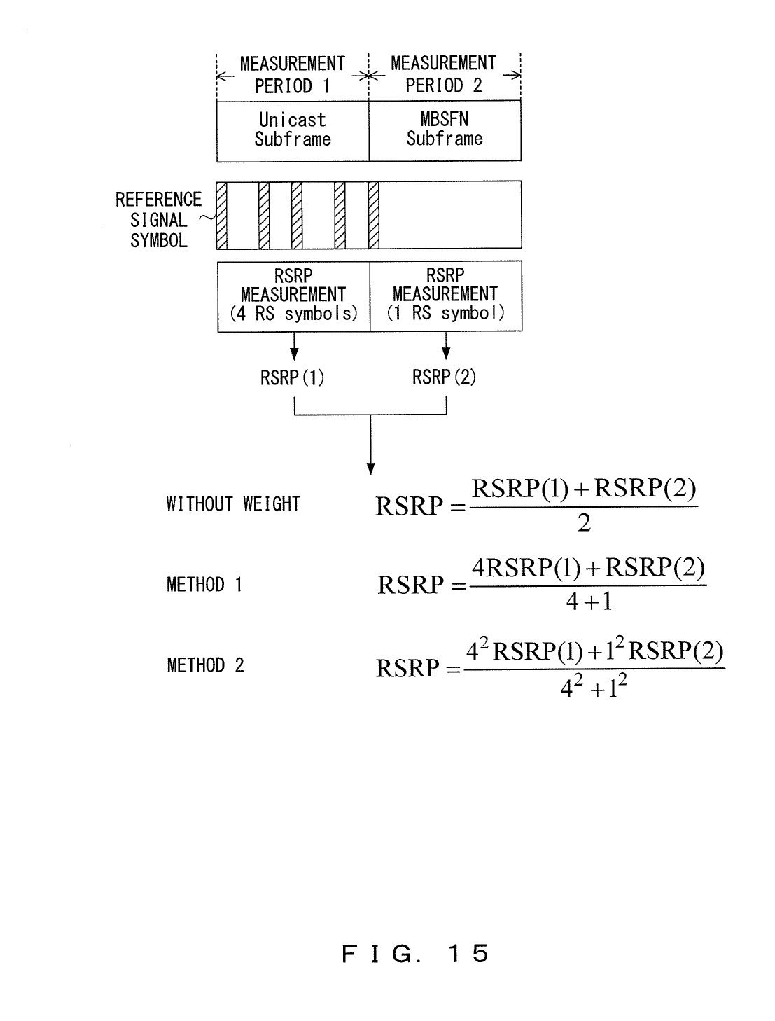

As illustrated in FIG. 14, also in the second embodiment as in the first embodiment, the numbers of the reference signal symbols in the measurement periods 1, 2, and 3 are 5, 2, and 8, respectively. However, in the second embodiment, the square of the number of reference signal symbols in a measurement period is used as a weight coefficient. Therefore, the RSRP measurement unit 17 in the second embodiment outputs W1=5²=25, W2=2²=4, and W3=8²=64 respectively as the weight coefficients corresponding to the measurement periods 1, 2, and 3.

As in the first embodiment, the weighted average calculator 24 calculates RSRP by calculating the weighted average using W1 through W3 for RSRP(1) through RSRP(3). However, as described above, different weight coefficients are used between the first and second embodiments. The weighted average in the second embodiment is illustrated in FIG. 14.

Thus, in the second embodiment, the square of the number of reference signal symbols in each measurement period is used as a weight coefficient. Therefore, according to the weighted average according to the second embodiment, as compared with the first embodiment, the contribution of the measurement value obtained in the measurement period (measurement period 2 in FIG. 14) in which the number of reference signal symbols is small becomes further smaller, and the contribution of the measurement value obtained in the measurement period (measurement period 3 in FIG. 14) in which the number of reference signal symbols is large becomes further larger. Therefore, according to the method in the second embodiment, as compared with the first embodiment, the measurement accuracy of RSRP is further improved.

### Simulation

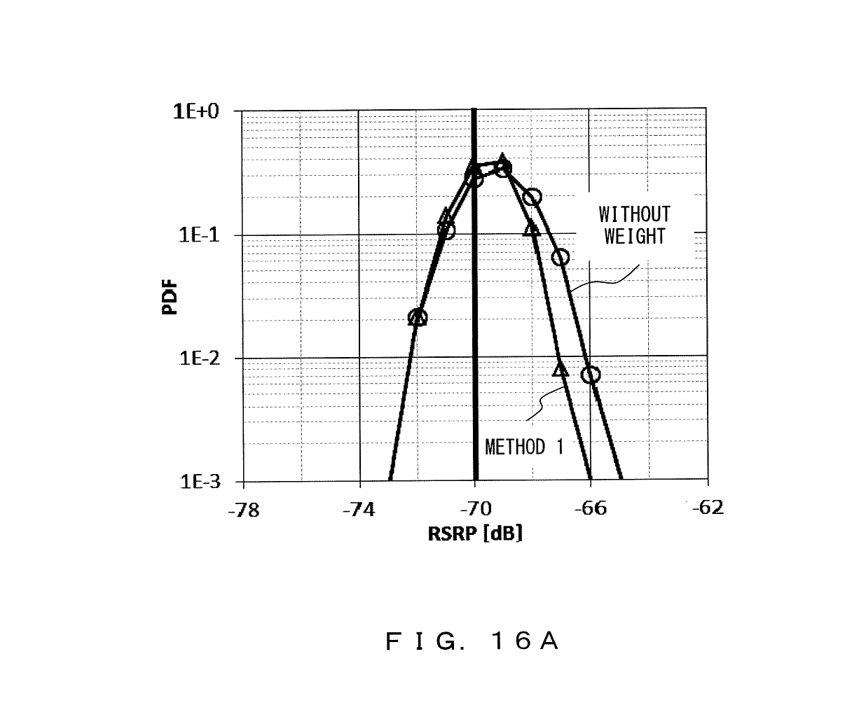

FIG. 15 is an explanatory view of a simulation model for the measurement accuracy of RSRP. In the simulation, RSRP is measured from two subframes. The length of each measurement period is “one subframe”. That is, in the measurement periods and 2, the measurement values RSRP(1) and RSRP(2) are calculated respectively. The two subframes input for RSRP measurement are “unicast” and “MBSFN”. Therefore, the number of reference signal symbols in the measurement periods 1 and 2 are “4” an “1” respectively. In this case, the accuracy or reliability of the measurement value RSRP(2) is lower than the measurement value RSRP(1). Furthermore, the terminal equipment which measures RSRP remains stationary. The ideal value of RSRP when there is no noise is −70 dBm. In the model above, RSRP is calculated in the following three methods.

In the “method without a weight”, RSRP is calculated by a simple average of RSRP(1) and (2).

The “method 1” corresponds to the first embodiment. RSRP(1) and RSRP(2) are weight averaged according to the number of reference signal symbols in a corresponding measurement period. The weight coefficients W1=4 and W2=1 are assigned to RSRP(1) and RSRP(2), respectively.

The “method 2” corresponds to the second embodiment. RSRP(1) and RSRP(2) are weight averaged according to the square of the number of reference signal symbols in a corresponding measurement period. The weight coefficients W1=4²=16 and W2=1²=1 are assigned to RSRP(1) and RSRP(2), respectively.

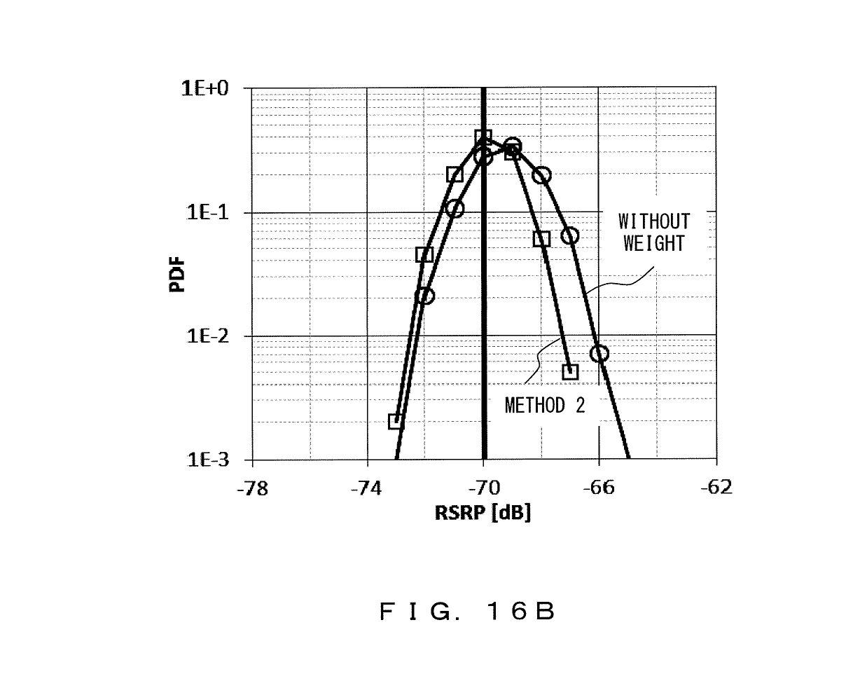

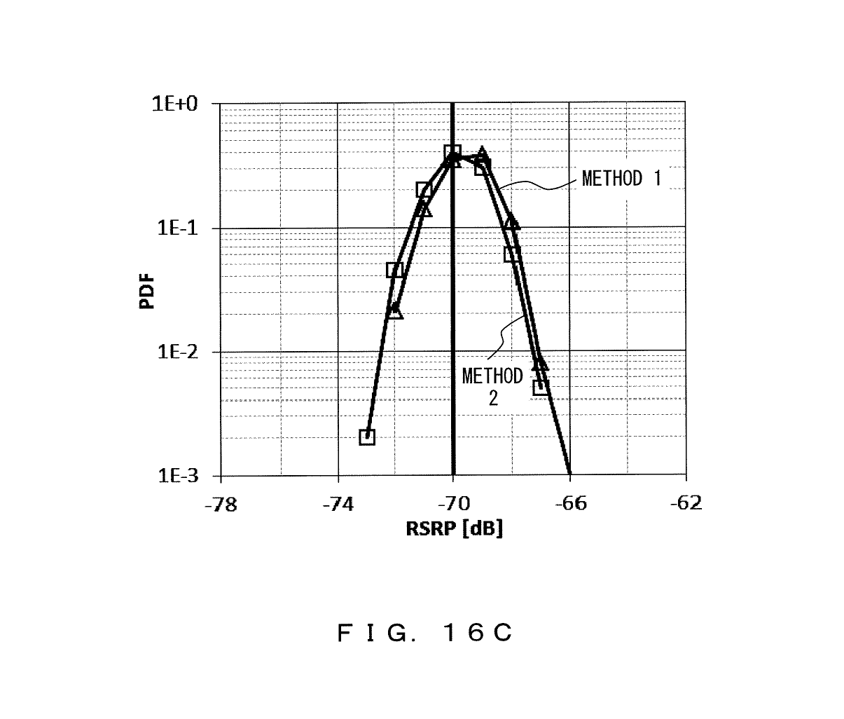

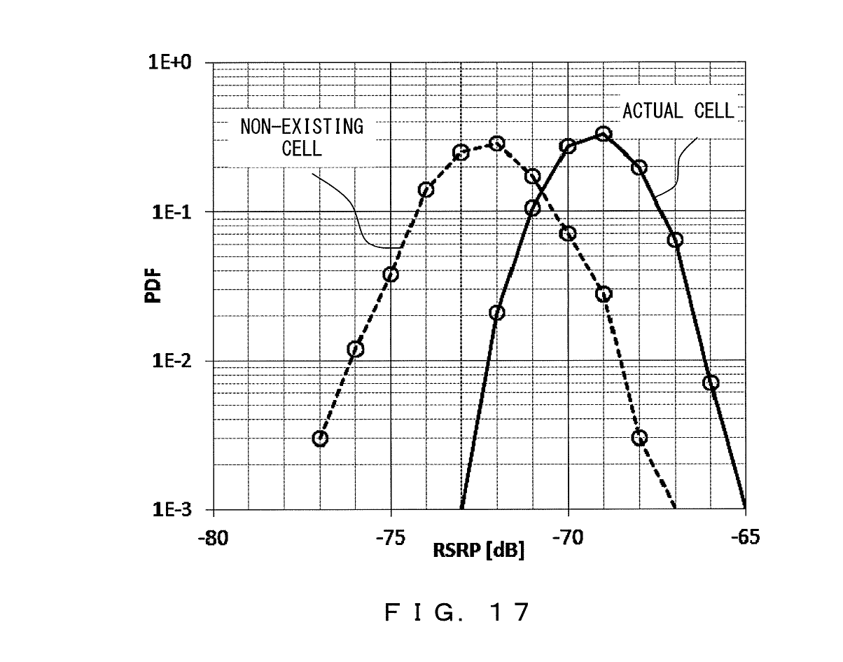

FIGS. 16A-16C illustrate the simulation results in the model illustrated in FIG. 15. The horizontal axis indicates RSRP. The vertical axis indicates probability density function (PDF). The circle, triangle, and square respectively indicate a comparison example, the method 1, and the method 2.

In FIG. 16A, the “method without a weight” and the method 1 are compared. In the measurement by the method 1 as compared with the “method without a weight”, there is a high probability that RSRP close to the ideal value (−70 dBm) is obtained. That is, according to the method 1, there is a low probability that RSRP having a large error with respect to the ideal value is obtained.

In FIG. 16B, the “method without a weight” is compared with the method 2. Also in this case, in the measurement by the method 2 as compared with the “method without a weight”, there is a high probability that RSRP close to the ideal value is obtained.

In FIG. 16C, the method 1 and the method 2 are compared. As compared with the method 1, there is a higher probability that RSRP close to the ideal value is obtained in the method 2.

Thus, since the RSRP measurement unit 17 obtains a weighted average using the number (or the square of the number) of the reference signal symbols, the influence of the measurement period having low measurement accuracy or reliability is reduced. As a result, as illustrated in FIGS. 16A and 16B, as compared with the “method without a weight”, there is a higher probability that RSRP close to the ideal value is obtained.

Described next is erroneous detection of a cell by a terminal equipment. A terminal equipment periodically performs a cell search to detect cell ID of a serving cell, and measures RSRP for the detected cell ID. However, in the cell search, a cell maybe erroneously detected although it does not actually exist. In this case, the terminal equipment measures RSRP not only for an actual cell which actually exists but also for a cell which actually does not exist.

In this case, if the averaging time for calculation of RSRP is sufficiently long, RSRP of the non-existing cell becomes sufficiently small. However, since the averaging time is finite, a value close to RSRP of an actual cell may be detected as RSRP of a non-existing cell.

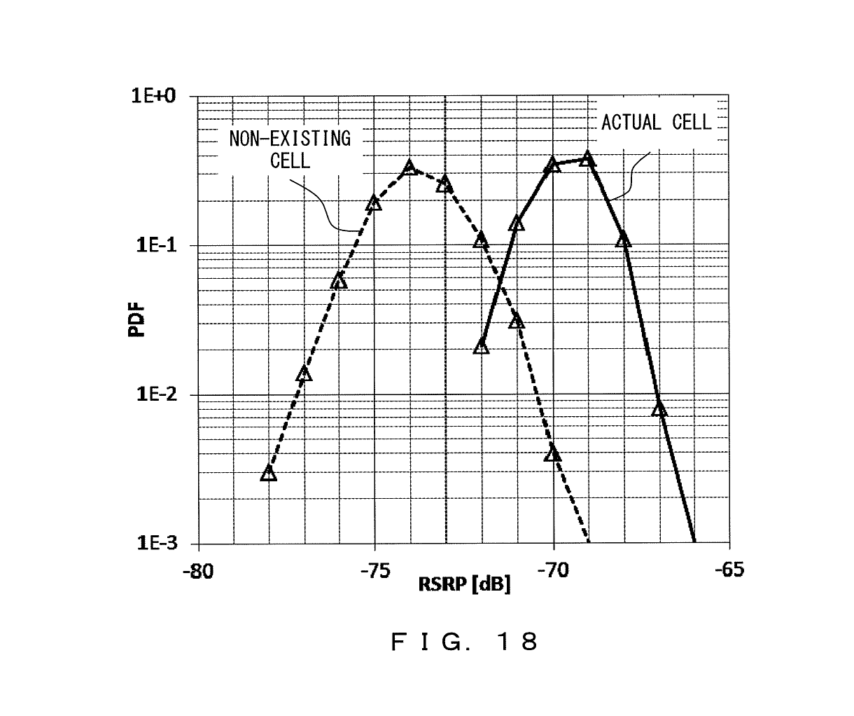

FIG. 17 illustrates the probability density function of RSRP calculated in the method without a weight on a “actual cell” and a “non-existing cell”. In this case, the two probability density functions largely overlap. In the RSRP area in which the two probability density functions overlap, the terminal equipment is not able to decide whether or not the detected cell is an “actual cell” or a “non-existing cell”.

For example, it is assumed that “threshold: −72.5 dBm” is set to detect an actual cell. In this case, when RSRP is higher than or equal to −72.5 dBm, the terminal equipment decides that a signal is received from an actual cell. On the other hand, when RSRP is smaller than −72.5 dBm, the terminal equipment decides that there is no cell corresponding to the received signal. Under this condition, when RSRP is measured by the “method without a weight”, the probability of erroneous detection (or erroneous decision) is 27% according to the simulation. The erroneous detection indicates detecting a “non-existing cell” as an actual cell.

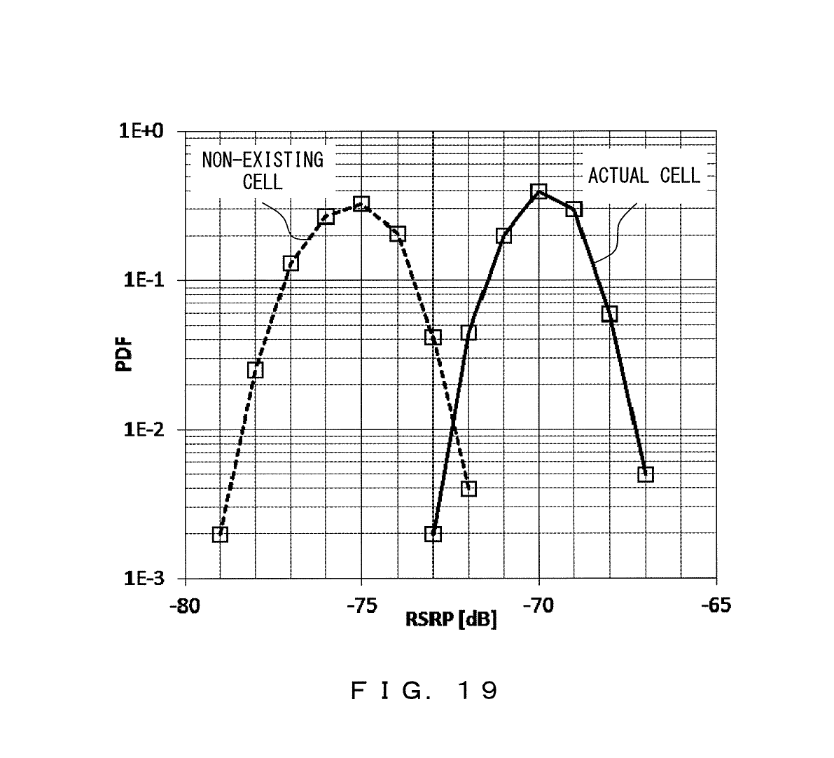

FIG. 18 illustrates the probability density function of RSRP calculated for the “actual cell” and the “non-existing cell” in the “method 1 (first embodiment)”. In this case, as compared with the example illustrated in FIG. 17, the area where two probability density functions overlap is small. As a result, when the threshold −72.5 dBm is set, the erroneous detection probability is reduced to about 0.6%.

FIG. 19 illustrates the probability density function of RSRP calculated for the “actual cell” and the “non-existing cell” in the “method 2 (second embodiment)”. In this case, as compared with the example illustrated in FIG. 18, the area where two probability density functions overlap is further smaller. As a result, when the threshold −72.5 dBm is set, the erroneous detection probability is reduced to approximately 0%.

### Handover

The terminal equipment measures RSRP of a serving cell and an adjacent cell, and reports the measurement result to a serving base station. The serving base station compares RSRP between the serving cell and the adjacent cell based on the report from the terminal equipment. Then, the serving base station performs a handover from the serving cell to the adjacent cell when, for example, RSRP of the adjacent cell is larger than RSRP of the serving cell.

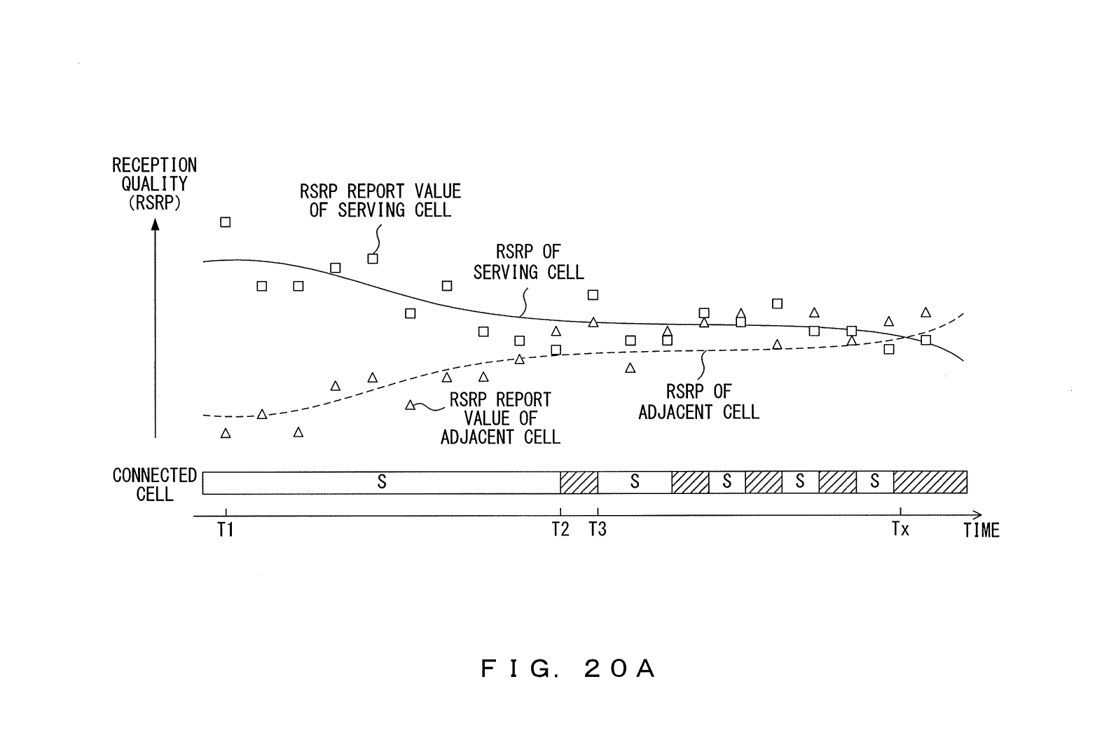

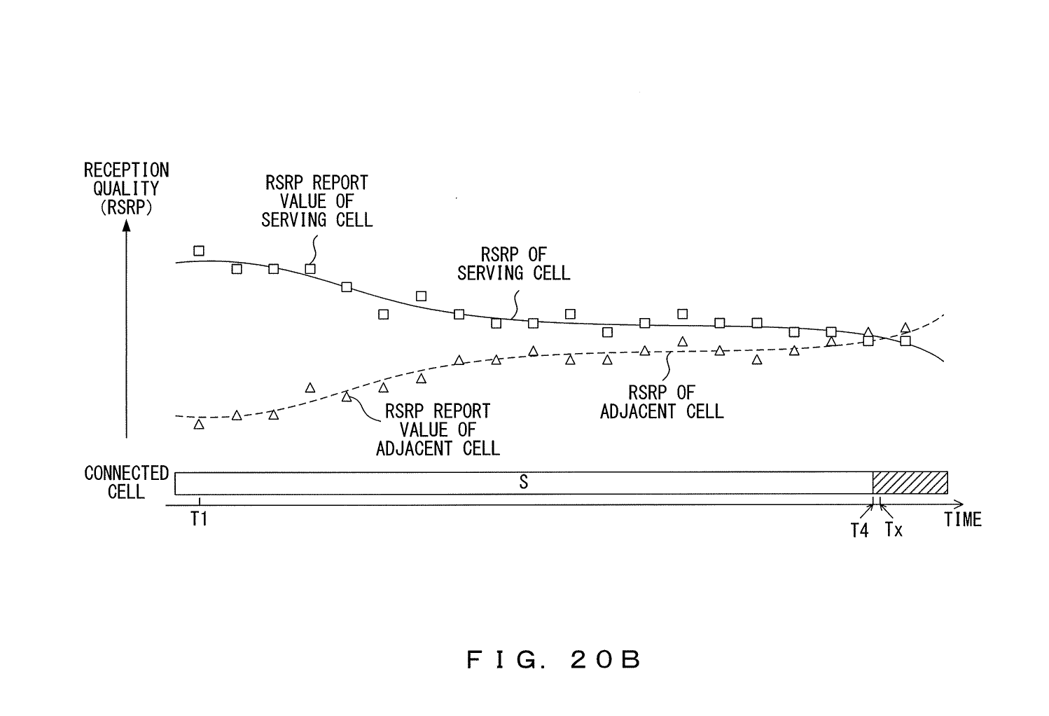

FIGS. 20A and 20B illustrate examples of a handover operation based on RSRP. In FIGS. 20A and 20B, the curve in solid line and the curve in broken line indicate actual RSRP of the serving cell and the adjacent cell, respectively. The square symbols and triangle symbols respectively indicate RSRP measured with respect to the serving cell and the adjacent cell by the terminal equipment. The deviation between the curve in solid line and the square symbol and the deviation between the curve in broken line and the triangle symbol correspond to measurement error.

At time T1, the terminal equipment receives a radio signal from both the serving base station and the base station of the adjacent cell. In this case, in the terminal equipment, RSRP of the serving cell is larger than RSRP of the adjacent cell. Afterwards, it is assumed that the terminal equipment moves in the direction toward the base station of the adjacent cell. That is, after the time T1, RSRP of the serving cell gradually decreases in the terminal equipment, and RSRP of the adjacent cell gradually increases. Then, at time Tx, it is assumed that RSRP of the adjacent cell exceeds RSRP of the serving cell.

FIG. 20A indicates the handover control when RSRP of low measurement accuracy is reported to the base station. In this example, at time T2, the measurement value of RSRP of the adjacent cell exceeds the measurement value of RSRP of the serving cell. Therefore, when the measurement result is reported, the serving base station performs a handover from the serving cell to the adjacent cell.

Afterwards, at time T3, the measurement value of RSRP of the serving cell exceeds the measurement value of RSRP of the adjacent cell. Therefore, when the measurement result is reported, the handover is performed again.

Similarly, each time the comparison results between the two measurement values of RSRP becomes inverted, a handover is performed. In FIG. 20A, the terminal equipment is connected to the serving cell in the time period S, and the terminal equipment is connected to the adjacent cell in the time period indicated by diagonal lines. Thus, when the measurement accuracy of RSRP in the terminal equipment is low, the handover is performed plural times when the difference in RSRP is small between the serving cell and the adjacent cell, thereby causing unstable communication state.

FIG. 20B indicates the handover control when RSRP of high measurement accuracy is reported to the base station. In this example, during period T1 through T4, the measurement value of RSRP of the serving cell continuously exceeds the measurement value of RSRP of the adjacent cell. Then, at time T4, the measurement value of RSRP of the adjacent cell exceeds the measurement value of RSRP of the serving cell, and a handover is performed. The time T4 is close to time Tx. That is, when the measurement accuracy of RSRP is high, a handover is performed with appropriate timing, thereby maintaining stable communication state during the handover.

Thus, if the measurement accuracy of RSRP is improved, the communication becomes stable during the handover. Therefore, if RSRP is measured in the method adopted in the RSRP measurement unit 17 according to the above-mentioned embodiments, the communication maintains a stable communication state.

### Other Embodiments

The length of the measurement period in which the measurement unit 22 measures RSRP is one subframe or two subframes in the embodiments above, but the present invention is not limited to these lengths. That is, the measurement period may be shorter than the subframe time.

With the configuration illustrated in FIG. 6, a plurality of RSRP measurement values are generated using a plurality of measurement units 22 (22-1 through 22-n), but the present invention is not limited to this configuration. That is, the measurement units 22 may sequentially generate a plurality of RSRP measurement values.

In the explanation above, the measurement unit 22 generates a received power value indicated by real number, but the present invention is not limited to this implementation. For example, the measurement unit 22 may output a correlation value among a plurality of channel states h₁, h₂, h₃, . . . which are estimated from a plurality of reference signal symbols allocated in the measurement period. The correlation value is calculated by, for example, multiplying a complex number indicating a channel state by a complex conjugate of a complex number indicating another channel state. In this case, the correlation value is expressed by a complex number. However, when the measurement period is sufficiently short, the correlation value is substantially equal to the received power of the reference signal symbol. Therefore, the value obtained by expressing the result of calculating a weighted average after the weighted average calculator 24 calculates the weighted average of a plurality of correlation values is substantially equal to RSRP calculated by the weighted average calculator 24 when the measurement unit 22 generates a received power value expressed by real number. Therefore, in the process of calculating RSRP, the correlation value of the channel state is one example of a received power value.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A receiver comprising:
a measurement unit configured to measure received power of a pilot signal symbol included in a received signal and generate a received power measurement value for each of a plurality of measurement periods; and
a calculator configured to calculate received power by calculating a weighted average of a plurality of received power measurement values obtained by the measurement unit based on the numbers of the pilot signal symbols that are included in respective measurement periods.

2. The receiver according to claim 1, wherein
the calculator calculates the received power by calculating the weighted average of the plurality of received power measurement values using the numbers of the pilot signal symbols that are included in respective measurement periods as weights of the weighted average calculation.

3. The receiver according to claim 1, wherein
the calculator calculates the received power by calculating the weighted average of the plurality of received power measurement values using squares of the numbers of the pilot signal symbols that are included in respective measurement periods as weights of the weighted average calculation.

4. The receiver according to claim 1 further comprising
a weight coefficient calculator configured to calculate a weight coefficient of each received power measurement value so that a received power measurement value corresponding to a measurement period including a larger number of pilot signal symbols is assigned a larger weight, wherein
the calculator calculates the weighted average of the plurality of received power measurement values using the weight coefficient calculated by the weight coefficient calculator to obtain the received power.

5. The receiver according to claim 4, wherein
the weight coefficient calculator calculates the weight coefficient according to information about an allocation of pilot signal symbols received from a base station connected to the receiver.

6. A method for measuring reception quality by a receiver, the method comprising:
measuring received power of a pilot signal symbol included in a received signal for each of a plurality of measurement periods to generate a plurality of received power measurement values; and
detecting reception quality by calculating a weighted average of the plurality of received power measurement values based on the numbers of the pilot signal symbols that are included in respective measurement periods.

7. A terminal equipment comprising:
a receiver circuit configured to receive a signal that includes a pilot signal symbol from a base station; and
a processor configured to process the received signal, wherein
the processor measures received power of the pilot signal symbol included in the received signal for each of a plurality of measurement periods to generate a plurality of received power measurement values, and
the processor detects reception quality by calculating a weighted average of the plurality of received power measurement values based on the numbers of the pilot signal symbols that are included in respective measurement periods.
